(19) United States
(12) Patent Application Publication
(10) Pub. No.: US 2026/0342762 A1
(43) Pub. Date: Oct. 29, 2026

(54) SYSTEMS AND METHODS FOR PROVIDING A PLATFORM FOR USER INTERACTIONS USING ARTIFICIAL INTELLIGENCE

(71) Applicant: Dipidi LLC, Nashville, TN (US)

(72) Inventors: Sarah Ali, Nashville, TN (US); Glahens Paul, Nashville, TN (US); James C. Seabury, III, Nashville, TN (US)

(21) Appl. No.: 19/659,482

(22) Filed: Apr. 27, 2026

Related U.S. Application Data
(60) Provisional application No. 63/795,949, filed on Apr. 28, 2025.

(51) Int. Cl. H04L 51/216; G06Q 10/1093; H04L 51/02

(52) U.S. Cl. CPC H04L 51/216; G06Q 10/1093; H04L 51/02

(57) ABSTRACT

A computer-implemented system and method for managing multi-user interactions using artificial intelligence are disclosed. Message data from a plurality of user computing devices across one or more group communication sessions is received and processed to generate a multi-user conversation state including participant-specific interaction data and contextual relationship data. Context is maintained across multiple communication sessions to provide a persistent coordination platform. One or more machine learning models are used to analyze the conversation state to determine a conversation context and group interaction parameters. Based on the conversation context and external data sources, a candidate real-world activity is selected and a structured activity recommendation is generated, including a proposed time and location. Navigation and coordination across multiple concurrent conversation sessions are facilitated, and real-world interactions among users are prioritized based on the conversation context and group interaction parameters. The structured activity recommendation is transmitted to at least two user computing devices.

### CROSS-REFERENCES TO RELATED APPLICATIONS

This application claims priority to U.S. Provisional Patent Application Ser. No. 63/795,949 filed Apr. 28, 2025, the entirety of which is incorporated by reference herein.

### TECHNICAL FIELD

The present disclosure generally relates to social networking and communication platforms, and more particularly to systems and methods for facilitating user interactions using artificial intelligence in multi-user environments.

### BACKGROUND

Social networking platforms and messaging applications have become primary tools for interpersonal communication, enabling users to connect, share information, and interact across geographic boundaries. Conventional platforms typically rely on user-initiated interactions, such as friend requests, direct messaging, or participation in static group chats. While these systems have improved connectivity, they generally lack intelligent mechanisms for dynamically forming and managing meaningful group interactions.

More recently, artificial intelligence (AI), including large language models (LLMs), has been incorporated into communication platforms to enhance user experiences. These systems are commonly deployed in one-on-one contexts, such as chatbots or virtual assistants, where AI responds to individual user inputs. However, such implementations are not well-suited for multi-user environments, where multiple participants interact simultaneously and conversational dynamics become significantly more complex.

In particular, existing AI systems struggle to effectively manage multi-party conversations due to limitations in tracking conversational context across multiple users, distinguishing between participants, and maintaining coherent dialogue over time. As a result, AI-generated contributions in group settings are often disjointed, lack personalization, or fail to account for group dynamics such as participation balance, tone, and evolving relationships among users.

Additionally, conventional social platforms typically rely on static or profile-based matching systems (e.g., shared interests, demographics, or manually selected groups) to connect users. These approaches do not account for real-time conversational behavior, communication styles, or interpersonal compatibility as expressed through actual interactions. Consequently, such systems may fail to foster meaningful or engaging group experiences.

Another limitation of existing platforms is the disconnect between digital interactions and real-world engagement. While users may communicate extensively through messaging applications or social media, these platforms generally do not provide effective mechanisms for translating online interactions into coordinated, in-person activities. Users are often required to manually plan, schedule, and coordinate such activities, which introduces friction and reduces the likelihood of real-world engagement.

Although some systems provide recommendations for events or local activities, these recommendations are typically generic, user-specific, or based on historical preferences, rather than being dynamically generated based on the real-time context of group conversations. Moreover, such systems do not integrate activity recommendations with group formation, conversational facilitation, and scheduling in a unified manner.

Existing platforms also lack mechanisms for evaluating and optimizing group interactions over time. For example, conventional group chats persist regardless of engagement quality, without consideration of factors such as participation levels, sentiment, responsiveness, or overall group cohesion. As a result, users may experience disengagement, conversational imbalance, or stagnation within group environments.

Furthermore, many current digital communication platforms are designed to maximize user engagement and screen time, often at the expense of meaningful interpersonal connections. This can contribute to digital fatigue and reduced incentives for real-world interaction, further exacerbating the gap between online communication and offline relationships.

### SUMMARY

In view of at least some of the above-referenced limitations associated with conventional communication platforms and artificial intelligence systems, an exemplary object of the present disclosure may be to provide systems and methods for managing multi-user interactions using artificial intelligence, wherein conversational data is processed to facilitate meaningful group interactions and coordinated real-world activities.

The present disclosure generally relates to social platforms, and more particularly to systems and methods for providing a platform for user interactions using artificial intelligence. A social platform can utilize machine learning models (e.g., an LLM) to match users into a group chat accessed via the users'computing devices. The LLM can facilitate the group chat based on the context of the chat to match the users with a group of other users that share similar interests and enable in-person meetings.

In various embodiments, the present disclosure provides an integrated computing platform configured to process multi-user communication data using one or more machine learning models to maintain a structured representation of group interactions. The platform may be configured to generate and continuously update a multi-user conversation state that preserves participant-specific context and relational information across a plurality of users within a group communication session. Based on the maintained conversation state, the platform may further perform context-aware processing to generate outputs including activity recommendations, system interventions, and coordination data, thereby enabling improved management of multi-user interactions, including persistent cross-session coordination, proactive generation of coordination outputs, structured plan creation and management, and integration of external data sources to facilitate real-world activity execution.

In some embodiments, the platform operates as a persistent coordination layer that maintains context across multiple group communication sessions associated with a user. The platform may generate and maintain user-level context and network-level context representing interactions across a plurality of sessions, groups, and participants. The persistent context may be used to inform coordination decisions including participant selection, activity generation, scheduling, and interaction management across sessions.

In some embodiments, the systems and methods described herein provide technical improvements in the processing of multi-user communication data by enabling maintenance of distinct participant-specific context within a shared conversational environment. Unlike conventional systems that process messages sequentially without preserving individualized context across participants, the disclosed systems utilize structured conversation state representations to improve contextual accuracy, reduce cross-participant ambiguity, and enhance downstream processing operations including activity selection and automated coordination.

In certain implementations, the platform may further include a data processing pipeline configured to receive message data, extract features associated with user interactions, generate participant-specific representations, and correlate the extracted features with external data sources including location-based data, calendar and scheduling data, event platforms, user preference data, and behavioral data sources. The pipeline may be configured to operate in real-time or near real-time to enable dynamic updating of the conversation state and responsive generation of system outputs.

In various embodiments, the present disclosure may provide a computer-implemented method for managing multi-user interactions, wherein message data associated with a plurality of user computing devices participating in one or more group communication sessions is received and processed to generate conversation context associated with the plurality of user computing devices, including interaction data associated with individual users and relational context among the plurality of users. The method may further include aggregating the conversation context across the one or more group communication sessions to generate a cross-session context associated with at least one user. The method may further include processing the cross-session context using one or more machine learning models to determine one or more contextual characteristics associated with a group communication session and identify one or more group interaction parameters. The method may further include generating a structured plan including at least a set of participants, a proposed time, and a proposed location, selecting a candidate real-world activity based on the conversation context, the group interaction parameters, and location-based data, generating a coordination output including at least an activity recommendation including a proposed time and location, and transmitting the activity recommendation to at least two of the user computing devices, wherein the conversation context is updated based on incoming message data to maintain context associated with individual users across the one or more group communication sessions.

In an exemplary aspect according to the method of claim 1, the method may further include analyzing the conversation context to determine silence duration, participation imbalance, or conversational cohesion, determining a timing condition for automated system intervention, and generating and inserting an AI-generated message into at least one of the group communication sessions, wherein the AI-generated message may be generated without receiving an explicit user request.

In another exemplary aspect according to the method of claim 2, the method may further include detecting tonal divergence within a group communication session and selecting a response strategy, wherein the AI-generated message comprises a mediating message configured to reduce the tonal divergence.

In another exemplary aspect according to the method of claim 1, identifying the one or more group interaction parameters may include determining participation distribution based on message frequency, response timing based on time intervals between messages, and sentiment variation based on changes in detected sentiment.

In another exemplary aspect according to the method of claim 1, selecting the candidate real-world activity may further include identifying a plurality of candidate activities, determining availability and scheduling constraints associated with the plurality of user computing devices, and selecting the candidate real-world activity based on the conversation context, the cross-session context, and the availability and scheduling constraints.

In another exemplary aspect according to the method of claim 1, generating the activity recommendation may further include generating a calendar appointment including at least the proposed time and location and transmitting the calendar appointment to the at least two of the user computing devices.

In another exemplary aspect according to the method of claim 1, the method may further include determining that an additional user computing device is compatible based on the cross-session context and adding the additional user computing device to at least one group communication session.

In another exemplary aspect according to the method of claim 1, the method may further include generating a second conversation context associated with a second group communication session and aggregating the conversation context and the second conversation context to generate the cross-session context.

In another exemplary aspect according to the method of claim 1, the one or more machine learning models may include one or more large language models configured to process natural language message data.

In another exemplary aspect according to the method of claim 1, generating the conversation context may further include generating interaction histories associated with each user computing device and maintaining the interaction histories across multiple messages and across multiple group communication sessions.

In another exemplary aspect according to the method of claim 1, selecting the candidate real-world activity may further include weighting location-based data based on proximity to the plurality of user computing devices.

In another exemplary aspect according to the method of claim 1, receiving the message data may include receiving communication data including text-based messages, voice-based inputs, or other multimodal communication data exchanged between at least two user computing devices.

In another exemplary aspect according to the method of claim 1, the method may further include determining geolocation data associated with the plurality of user computing devices.

In another exemplary aspect according to the method of claim 1, selecting the candidate real-world activity may further include correlating the conversation context with user preference data associated with the plurality of users and behavioral data derived from prior interactions.

In another exemplary aspect according to the method of claim 1, transmitting the activity recommendation may include transmitting the activity recommendation to a user interface associated with each of the at least two user computing devices.

In another exemplary aspect according to the method of claim 1, the method may further include determining a relationship stage based on the cross-session context and generating a user interface element based on the relationship stage.

In another exemplary aspect according to the method of claim 1, the method may further include selecting a machine learning model from among a plurality of machine learning models based on conversation complexity, context depth, or responsiveness requirements.

In another exemplary aspect according to the method of claim 1, processing the conversation context may include maintaining conversational context across multiple participants by identifying and tracking individual users across the one or more group communication sessions.

In another embodiment, a system for managing multi-user interactions is provided, wherein the system includes at least one processor, at least one memory storing non-transitory computer-executable instructions, and one or more machine learning models, and wherein execution of the instructions causes the system to receive message data associated with a plurality of user computing devices, generate conversation context including interaction data associated with individual users and relational context among the plurality of users, aggregate the conversation context across multiple group communication sessions to generate a cross-session context, process the conversation context to determine one or more contextual characteristics associated with a group communication session and identify one or more group interaction parameters, select a candidate real-world activity based on the conversation context, the group interaction parameters, and location-based data, generate a structured plan and initiate coordination actions associated with the structured plan, and transmit an activity recommendation to at least two of the user computing devices.

In another embodiment, a system including a computing device and a plurality of user computing devices is provided, wherein the computing device is configured to receive message data from the plurality of user computing devices, generate conversation context associated with one or more group communication sessions, aggregate the conversation context across the one or more group communication sessions to generate a cross-session context, determine a relationship stage based on the cross-session context, generate a structured plan including at least participants, a proposed time, and a proposed location based on the cross-session context, generate a coordination output including at least an activity recommendation based on the cross-session context and location-based data, generate a user interface element based on the relationship stage, and transmit the coordination output and the user interface element to at least two of the user computing devices.

### BRIEF DESCRIPTION OF THE DRAWINGS

The accompanying drawings, which are incorporated in and constitute a part of the specification, illustrate exemplary embodiments of the disclosure. Together with the description, they serve to explain the objects, advantages, and principles of the disclosure.

FIG. 1 is a block diagram illustrating an example embodiment of a system of the present disclosure.

FIG. 2 is a sequence flow diagram illustrating an example embodiment of a system of the present disclosure.

FIG. 3 is a flowchart diagram illustrating an example embodiment of a method of the present disclosure.

### DETAILED DESCRIPTION

Reference will now be made in detail to exemplary embodiments of the disclosure, some aspects of which are illustrated in the accompanying drawings.

Reference throughout this specification to “one embodiment,” “an embodiment,” “another embodiment,” or similar language means that a particular feature, structure, or characteristic described in connection with the embodiment is included in at least one embodiment. Thus, appearances of the phrases “in one embodiment,” “in an embodiment,” “in some embodiments,” and similar language throughout this specification may, but do not necessarily, all refer to the same embodiment and should be understood to mean “one or more but not necessarily all embodiments” unless expressly specified otherwise.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. As used herein, the term “a,” “an,” or “the” means “one or more” unless otherwise specified. The term “or” means “and/or” unless otherwise specified.

Multiple elements of the same or a similar type may be referred to as “Elements 102(1)-(n)” where n may include a number. Referring to one of the elements as “Element 102” refers to any single element of the Elements 102(1)-(n). Additionally, referring to different elements “First Elements 102(1)-(n)” and “Second Elements 104(1)-(n)” does not necessarily mean that there must be the same number of First Elements as Second Elements and is equivalent to “First Elements 102(1)-(n)” and “Second Elements (1)-(m)” where m is a number that may be the same or may be a different number than n.

The systems and methods of the present disclosure provide a platform that leverages artificial intelligence (AI) to facilitate meaningful connections and prioritize real-world interactions over digital engagement. For instance, the platform may be provided via a user computing device (e.g., a mobile device), allowing the user to facilitate meaningful connections with the other users using the platform via their user computing devices (e.g., a mobile device). The platform utilizes an integrated AI-driven system that may actively participate in group chats, facilitate meaningful connections between users, and transition platform-based interactions into real-world meetings.

In various embodiments, the systems and methods described herein provide a technical improvement in the processing of multi-user communication data by generating and maintaining a structured representation of group interactions that preserves both participant-specific interaction data and relational context across multiple users. Conventional communication systems process messages sequentially or in isolation, resulting in loss of contextual continuity and ambiguity in multi-party environments. In contrast, the disclosed system generates a persistent conversation context that enables improved interpretation, coordination, and downstream processing of communication data across multiple participants.

In some embodiments, the structured conversation context is stored in a memory as a dynamically updated data structure that is accessed and modified by the computing device during execution of the machine learning models. The data structure may be indexed by user identifiers and time-based keys to enable efficient retrieval and incremental updating without reprocessing prior message data. The computing device may allocate memory resources and processing threads to independently update portions of the data structure corresponding to different users or interaction segments, thereby improving processing efficiency and reducing computational latency in multi-user environments.

In some embodiments, the platform may operate as a persistent coordination layer configured to maintain user-level and network-level context across a plurality of group communication sessions. Rather than limiting analysis to a single group communication session, the computing device may aggregate interaction data, relational context, and behavioral signals across multiple sessions associated with a given user or set of users. This persistent context may include historical interaction patterns, prior group compositions, engagement metrics, and prior coordination outcomes, which are stored and continuously updated to inform subsequent coordination decisions. In some embodiments, the platform may further support direct interaction between an individual user and the system via a conversational interface, wherein the user may communicate with the system independently of a group communication session. Through such direct interaction, the user may provide input data including preferences, scheduling constraints, plan modifications, or inquiries regarding existing or proposed plans. The system may process such direct user interactions in conjunction with the persistent context and cross-session data to generate coordination outputs, update structured plans, or provide plan status information.

The persistent coordination layer may maintain a cross-session context data structure that links multiple conversation contexts associated with different group communication sessions. The computing device may utilize the cross-session context to identify recurring interaction patterns, infer relationship strength between users, and determine compatibility across different group configurations. The cross-session context may be indexed by user identifiers and temporal markers, enabling retrieval of relevant historical interaction data without reprocessing prior communication sessions.

The platform can include integrated group chat facilitation with real-time matching, a real-time localized activity suggestion system, multi-party AI context management, and advanced large language model (LLM) integration and context optimization. These features of the platform may be implemented with a mobile front-end, a real-time backend, an AI processing pipeline, localized data integration, and a privacy-preserving architecture. The platform provides advancements over other AI-facilitated chat systems by integrating group formation, AI-mediated interactions, and localized real-world meetings within one platform, analyzing real-time conversations to combine with localized data sources to create timely and relevant group activities, managing multi-user conversations with AI, and AI-based identification of individual members within a group to provide contextually relevant and personalized responses, while current AI-based implementations cannot learn such nuances in group dynamics, frequently confuse participant roles, and fail to maintain coherent multi-party conversations.

In some embodiments, the platform may be implemented as a multi-stage processing pipeline including a message ingestion module, a feature extraction module, a conversation context generation module, a contextual analysis module, and a decision engine configured to generate outputs including activity recommendations and system interventions. Each module may operate independently or in conjunction with one or more machine learning models to transform raw message data into structured representations and actionable outputs.

In some embodiments, the decision engine may be configured to operate proactively by continuously analyzing both session-level and cross-session context to initiate coordination actions without requiring explicit user input. Such actions may include generating activity recommendations, suggesting participants for a group interaction, issuing conversational prompts, or providing social engagement recommendations based on inferred user intent and interaction patterns.

The outputs generated by the system are not limited to activity recommendations and may include participant selection recommendations, conversational nudges, engagement optimization prompts, and social wellness recommendations. These outputs may be dynamically selected based on contextual characteristics, user preferences, and cross-session behavioral patterns.

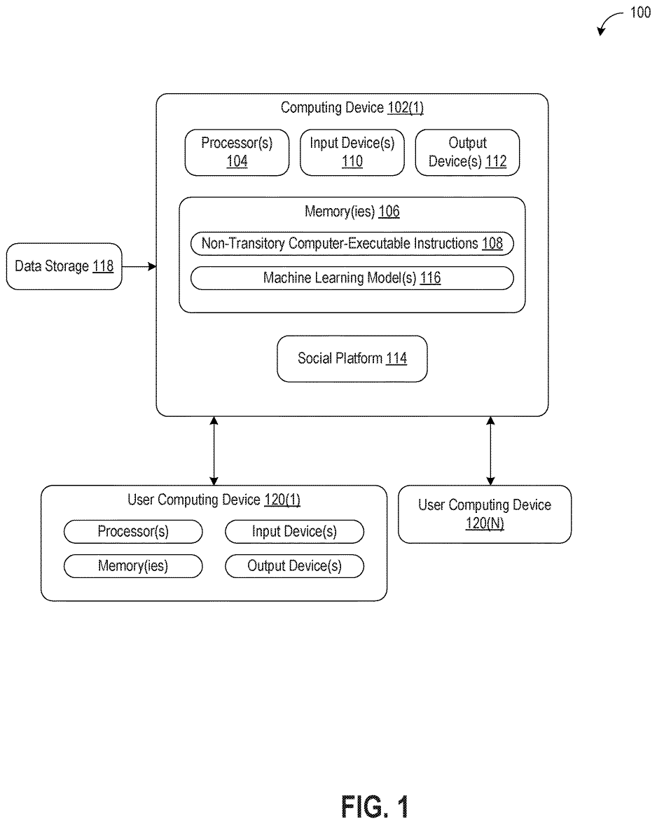

FIG. 1 is a block diagram illustrating an example embodiment of a system 100 of the present disclosure. The system 100 can include a computing device 102 (e.g., a server, central computing device, cloud computing device, etc.) with at least one processor 104 and at least one memory 106. The at least one memory 106 can store non-transitory computer-executable instructions 108. The computing device 102 can also comprise one or more input devices 110 and one or more output devices 112. The non-transitory computer-executable instructions 108, upon execution by the at least one processor 104, can cause the computing device 102 to perform operations for providing a platform for user interactions using artificial intelligence. The computing device 102 may further include a context management module configured to generate and maintain conversation context, a parameter extraction module configured to identify group interaction parameters, and a recommendation engine configured to select candidate activities based on processed data. In some embodiments, these modules may be implemented as microservices within a distributed computing environment.

The computing device 102 may provide a social platform 114 that is accessible by user computing devices 120(1)-120(N) (collectively, user computing devices 120) (e.g., mobile devices, tablet computers, laptop computers, etc.) and utilizes one or more machine learning models 116 to facilitate the platform 114 and interactions between the user computing devices 120. The system 100 may include a plurality of user computing devices 120, each associated with a user and communicatively coupled to the computing device 102 (e.g., over a network) to provide the user computing devices 120 with access to the platform 114. Each of the user computing devices 120 may include at least one processor, at least one memory, one or more input devices, and one or more output devices. The user computing devices 120 may transmit message data, metadata, and optional sensor data (e.g., location data) to the computing device 102. The computing device 102 may normalize, timestamp, and associate the received data with corresponding users to enable accurate tracking of individual participation within a group communication session.

In some embodiments, the computing device 102 may determine geolocation data associated with each of the user computing devices based on GPS data, network-based location data, or user-provided location inputs. The geolocation data may be used to select or filter candidate activities and to weight location-based data based on proximity to the users.

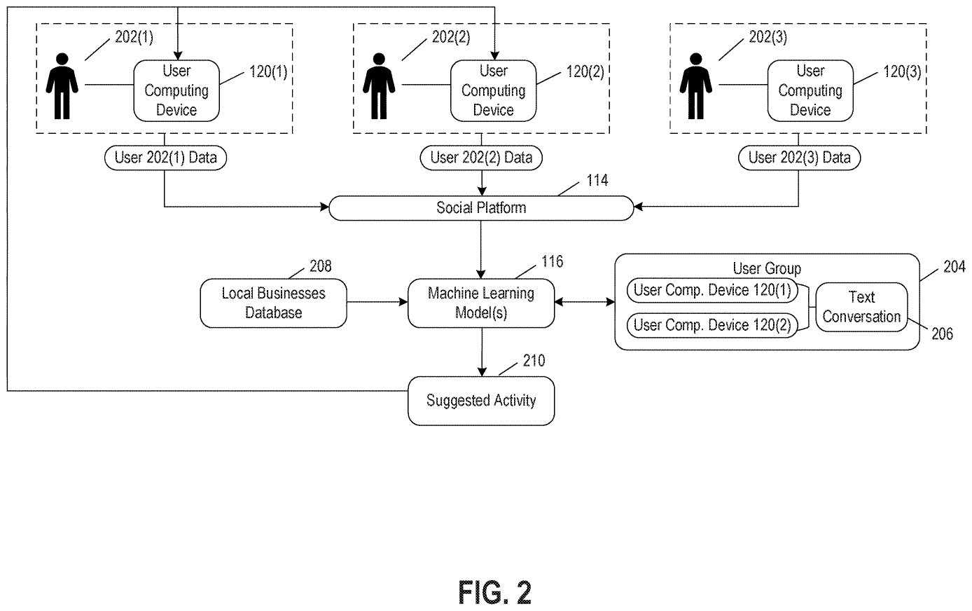

FIG. 2 is a sequence flow diagram illustrating an example embodiment of a system of the present disclosure. The system 100 may include integrated group chat facilitation with real-time matching, a real-time localized activity suggestion system, multi-party AI context management, and advanced LLM integration and context optimization. These features of the system 100 may be implemented with a mobile front-end, a real-time backend, an AI processing pipeline, localized data integration, and a privacy-preserving architecture. These components of the system 100 may enable the presentation and use of the platform 114 to provide a platform for user interactions using artificial intelligence. Additionally, an anti-addictive framework designed to minimize digital addiction and maximize meaningful offline engagements among users can measure and incentivize real-world connections among users.

In some embodiments, message data may be preprocessed to extract features including linguistic features, temporal features, and user-specific identifiers. Linguistic features may include tokenized text, sentiment scores, and semantic embeddings. Temporal features may include response timing, message frequency, and inactivity duration. These features may be used to generate interaction data associated with individual users.

In some embodiments, the group interaction parameters may be computed based on the extracted features from the message data. For example, participation distribution may be determined by calculating message frequency per participant, response timing may be determined based on time intervals between successive messages, and sentiment variation may be determined based on changes in sentiment scores across the group communication session. These parameters may be updated dynamically as new message data is received.

The integrated group chat facilitation with real-time matching provides group conversation facilitation combined with real-time matching technology, and may include real-time group formation by dynamically creating groups based on real-time conversation data, compatibility metrics, and/or ongoing relationship evaluations. A matching system based on communication styles, group interaction dynamics, and/or multi-faceted compatibility metrics may be employed by the machine learning model(s) 116, rather than a traditional static, interest-based approach, to group users together. For example, a group 204 may be created that includes user computing device 120(1) associated with user 202(1) and user computing device 120(2) associated with user 202(2), while user computing device 120(3) associated with user 202(3) is not included in the group 204, based on conversation data, the group including a text conversation 206 among users 202(1) and 202(2) of the user computing devices 120(1) and 120(2). AI algorithms implemented by the machine learning model(s) 116 may determine optimal moments for AI intervention in a conversation between a group of users 202 (e.g., a group text chat) by analyzing the conversation context, silence duration, participation, and/or group cohesion. In some embodiments, the machine learning model(s) 116 may further determine optimal moments for AI intervention based on data received outside of the group communication session, including data derived from direct interactions between an individual user and the system via a one-on-one conversational interface. Such direct interactions may include expressions of user intent, preferences, emotional states, or social signals (e.g., a user indicating a desire to reconnect with another user), which may be processed in conjunction with the conversation context and cross-session context to trigger coordination actions. For instance, the machine learning model(s) 116 may include LLMs that can analyze the natural language text in a text conversation between multiple users 202, each using a user computing device 120, and make decisions based on the analyzed conversation, such as the context, silence duration between users'text responses, user participation, and/or group cohesion, to determine the proper time for an AI intervention in the conversation, such as AI-generated text prompts to the group about the issue to facilitate the conversation. The conversation context may include a structured data object comprising user-specific interaction histories, relational mappings between users, and aggregated conversational features. The system may update the conversation context incrementally as new message data is received, enabling real-time adaptation to evolving group dynamics. In some implementations, the AI algorithms implemented by the machine learning model(s) 116 may analyze the natural language text in a text conversation between multiple users and determine that there is a conflict in the group to be resolved by AI intervention in the conversation. For instance, the machine learning model(s) 116 may identify conflict-related characteristics in the text conversation, such as tonal escalation, determine a de-escalation strategy to apply to the situation based on the conflict-related characteristics, as well as the conversation context, silence duration, participation, and/or group cohesion, generate a mediating prompt based on the de-escalation strategy, and send the mediating prompt to the group to resolve the issue and facilitate the conversation. In some embodiments, the system may initiate coordination actions based on such direct user interactions, including generating prompts or notifications to other users, suggesting reconnection opportunities, or facilitating plan creation between users based on inferred intent.

In some embodiments, the conversation context may be represented as a multi-dimensional data structure comprising a plurality of user nodes and relational edges, where each user node corresponds to a participant and stores interaction data including message frequency, sentiment trends, and response latency, and each relational edge represents interactions between users, including reply patterns and conversational dependencies.

The group text chat (i.e., text conversation 206) may include an AI-based chat bot that each user in the group can interact with, such as with a one-on-one interaction between a user and the chat bot. The AI algorithms implemented by the machine learning model(s) 116 may generate prompts in response to a user's interaction with the AI-based chat bot and insert the prompts into the group text chat, which the user may also interact with. For example, a user can ask the AI-based chat bot for information about current groups, an analysis of the user, and recommendations for meeting other members of a group. In some implementations, the matching system that groups users together may integrate the AI-based chat bot to ask users information that is used to match users into groups. In some embodiments, additional functions, such as onboarding a new user to the platform 114, may be assisted by the AI-based chat bot (e.g., to ask users for their information).

The integrated group chat facilitation with real-time matching may also include group dissolution by removing groups based on group health and inactivity using a scoring system. For instance, auto-dissolution logic may be applied, which may include a timed evaluation loop that scores the health of a group after a predetermined amount of days, flags the group if the score is below a predetermined threshold, and automatically redistributes the users in the group or dissolves the group. In some embodiments, groups can be scored for group-chemistry optimization metrics, which may include calculating a chemistry score derived from turn-taking entropy, sentiment variance, and/or response latency, as non-limiting examples. For example, sentiment variance may be determined by performing sentiment analysis to identify the emotional tone of the text conversation and changes in the tone over time (e.g., calculating the difference between positive and negative sentiments). A group with a higher chemistry score compared to other groups'chemistry scores may be prioritized based on a target score window, where the group with the higher chemistry score is within the target score window.

The real-time localized activity suggestion system provides a mechanism for using real-time data from local businesses and events. Context-aware recommendations may be generated by the machine learning model(s) 116 based on the analysis of the conversation context and an analysis of the users'profiles, such as a user's information and preferences, to create contextualized local activity recommendations for the group. An automated coordination system may be integrated to handle logistics, scheduling, and participant availability to reduce friction and encourage real-world interactions between the users in the group, which may be integrated into a calendar system of the user computing devices 120. Integration of the platform 114 with local business databases 208 (e.g., data storage 118) may provide timely, relevant, and personalized activity suggestions for the users in the group chat to enhance local engagement, as the computing device 102 can access the local business databases, obtain data about local businesses (e.g., operating hours, location, activities), and generate one or more activity suggestions 210 based on the local business data, the analysis of the conversation context, and the analysis of the users' profiles. In some embodiments, user preference data associated with the plurality of users may be stored and used in selecting the candidate real-world activity, including preferences related to activity type, time of day, and past participation behavior. The system may correlate the conversation context with the user preference data to refine activity selection. The selection of the candidate activity may be performed using a ranking model that evaluates candidate activities based on weighted combinations of contextual characteristics, group interaction parameters, and external data attributes. The ranking model may be trained using historical interaction data and feedback signals to optimize selection accuracy. When the activity suggestion is accepted by the group, a calendar appointment with the date, time, and location information may be generated and sent to a calendar application of the user computing devices 120 of the users in the group. Such an integration of group formation, AI-mediated interactions, and localized real-world meetup facilitation, using real-time conversation analysis combined with localized data sources, offers precision in facilitating timely and relevant group activities. An evaluation metric may be used to evaluate the platform's 114 ability to create the activity suggestions. For example, the evaluation metric may be a score defined by a product of the chat enthusiasm, proximity (e.g., to the location of the activity), and historical attendance, and the computing device 102 may optimize the evaluation metric. The chat enthusiasm may be determined by the machine learning model(s) 116 analyzing the text conversation to determine the enthusiasm of the text conversation. In some embodiments, the evaluation metric may be integrated with a screen-time minimization, where minimal screen time is associated with a greater ability of the platform 114 to create the activity suggestions. When the date of the activity has passed, the platform 114 may prompt the users for comments on the activity, which may be used to reinforce the matching system by the machine learning model(s) 116 in a feedback loop. In some embodiments, selecting the candidate real-world activity may further include determining availability and scheduling constraints associated with the plurality of user computing devices, including calendar availability, preferred time windows, and location constraints. The system may evaluate candidate activities based on compatibility with the determined availability and scheduling constraints of the users. In some embodiments, candidate activities may be filtered out based on incompatibility with one or more constraints, including distance thresholds, scheduling conflicts, user preferences, or safety considerations. The system may apply exclusion rules prior to ranking candidate activities to reduce computational overhead and improve recommendation relevance.

In some embodiments, the system may be configured to detect intent to coordinate a real-world activity from the conversation context and generate a structured plan associated with the group communication session. The structured plan may include at least a set of participants, a proposed time, a proposed location, and one or more coordination parameters.

The computing device may facilitate plan management by tracking plan state transitions, including proposed, pending confirmation, confirmed, and completed states. The system may update the structured plan based on participant inputs, scheduling constraints, or changes in conversation context.

In some embodiments, the system may enforce coordination workflows associated with the structured plan. For example, the system may require explicit confirmation from a threshold number of participants before finalizing the plan, apply configurable confirmation thresholds, or automatically generate follow-up prompts to participants to resolve outstanding coordination parameters.

Coordination actions associated with the structured plan may include a combination of user-confirmed actions and automatically initiated actions. For example, finalization of the structured plan may require explicit user approval, while intermediate actions such as reminders, nudges, or availability requests may be automatically generated by the system.

In some embodiments, a decision engine may integrate outputs from the contextual analysis module and external data sources to generate activity recommendations. The decision engine may apply rule-based logic, machine learning models, or hybrid approaches to evaluate candidate activities and determine an optimal recommendation.

The multi-party AI context management may include concurrent context handling for managing multiple simultaneous conversation contexts, maintaining personalized interaction histories, and adapting responses based on evolving group dynamics, and participation balancing for detecting and correcting imbalances in participation to promote inclusivity and engagement without disrupting the conversation flow. For instance, AI algorithms of the machine learning model(s) 116 may manage complex multi-user conversations and be optimized for relational depth, group cohesion, and user participation equity. The system may maintain multiple concurrent conversation contexts in parallel, each associated with a different group communication session, and may allocate computational resources dynamically to ensure efficient processing of each context.

The advanced LLM integration and context optimization may include an architecture for optimized use of LLMs (e.g., the machine learning model(s) 116) within the system 100. Context compression and management can maintain deep interaction history and relational context within token constraints to ensure coherent and consistent AI interactions. Hybrid AI model routing can dynamically select and orchestrate different machine learning model(s) 116 based on interaction complexity, context depth, and conversational responsiveness. Model selection may be performed dynamically by a routing component that selects among a plurality of machine learning models based on characteristics of the conversation context, including complexity, length, and number of participants. The selection may include evaluating model performance metrics and selecting a model based on predicted inference efficiency and contextual accuracy. For example, lightweight models may be used for simple interactions, while larger models may be used for complex group dynamics. A persona consistency engine can ensure coherent AI personality traits, conversation style, and relationship memory across interactions between users to strengthen user engagement and relational continuity, such as with relationship-stage awareness (e.g., introduction, bonding, maintenance).

In some embodiments, contextual characteristics associated with a group communication session may include aggregated measures derived from the conversation context, such as engagement level, conversational momentum, sentiment trajectory, and interaction density. These contextual characteristics may be used to inform downstream processing and decision-making.

In some embodiments, the contextual characteristics may be derived by applying aggregation functions to the conversation context, including statistical aggregation of message frequency, temporal analysis of response intervals, and sentiment aggregation across participants. For example, engagement level may be determined based on message density over time, conversational momentum may be determined based on changes in participation rates, and sentiment trajectory may be determined based on variations in sentiment scores across sequential messages.

The anti-addictive framework may include screen time minimization techniques and an offline-interaction score to minimize digital addiction and maximize meaningful offline engagements among users, which can measure and incentivize real-world connections among users. The screen time minimization techniques may include throttled push-notifications to the user computing devices 120 for a defined frequency, such as once per day. The offline-interaction score may be generated for each user based on the user's engagement in their groups and the frequency by which the user attends the scheduled activities with their groups. The machine learning model(s) 116 may use the offline-interaction score to match users into groups (e.g., as part of the matching system). In some embodiments, such scoring systems may be used as auxiliary signals within the machine learning pipeline and may not be required for operation of the core system. For example, users with higher scores are more likely to be matched together into groups and users with lower scores are more likely to be matched together into groups, so that users with similar engagement levels can be grouped together. In some embodiments, the score may be used to gate extra features, such as more features for users with higher scores.

Additional metrics and analytics may be calculated and used throughout the platform 114. Example metrics may include a conversation-depth index that shows relational progress, a group-cohesion trend that drives re-matching users into groups or dissolving groups, and a connection-strength evolution that is outcome-oriented.

In one example, groups of users using the platform 114 may be formed by the machine learning model(s) 116 matching users into groups (e.g., based on communication styles, group interaction dynamics, and/or multi-faceted compatibility metrics), and the group's conversation may be facilitated by the machine learning model(s) 116, which also provide contextual activity recommendations for the group, automatic scheduling of activities for the group, and post-meetup relationship strengthening among the group.

In another example, existing relationships among users may be enhanced by the platform 114 using the machine learning model(s) 116 for real-time analysis of group interactions, depth-of-connection enhancement, conflict-resolution, activity suggestions, and optimized participation balance.

In another example, the platform 114 may provide group dynamics evolution management by the machine learning model(s) 116 detecting shifts in group dynamics, proactively managing group transitions, seamlessly integrating new group members, and adapting group activities to evolving relational contexts.

Unlike existing applications, where AI interactions predominantly involve one individual engaging with multiple AI models, fail to distinguish clearly among group participants, struggle to grasp nuances in group dynamics, confuse participant roles, and fail to maintain coherent multi-party conversations, the system 100 of the present disclosure can accurately identify and track individual group members, understand group dynamics and roles, and maintain multi-party conversations, thereby improving computational processing of multi-user communication data by reducing ambiguity, maintaining participant-specific context, and enabling more accurate downstream decision-making.

The improved ability of the system to maintain participant-specific context and relational data across a multi-user conversation session enables more efficient processing of communication data and reduces ambiguity in interpreting user interactions. This results in fewer computational errors in downstream processes, including recommendation generation and scheduling coordination, and reduces the need for repeated processing of historical message data.

Technical implementations of the system 100 to provide the platform 114 for use by the user computing devices 120 may include a front-end user interface for cross-platform user interaction, a real-time backend for real-time messaging and notifications for real-time interactions among users, an AI processing pipeline integrating multiple machine learning model(s) 116 for natural language understanding, sentiment analysis, relationship tracking, and activity recommendation, localized data integration with external databases for real-time localized business and event information, and/or privacy-preserving architecture ensuring user privacy while providing personalized and meaningful group interactions. The AI processing pipeline may include feature extraction stages, context generation stages, and decision stages, each of which may be implemented using one or more machine learning models or rule-based components. For example, the user interface may include a dynamic interface based on relationship stages, where elements may be generated for the user interface based on the relationship stages. Example implementations of the privacy-preserving architecture may include on-device embedding generation and/or differential-privacy noise.

In some embodiments, the platform 114 may provide AI-implemented (e.g., via the machine learning model(s) 116) voice-interactive group facilitation, enhanced image and activity recognition for contextual understanding, location-driven group formation, emotional intelligence for conflict and relationship management, and/or cross-group relational dynamics optimization.

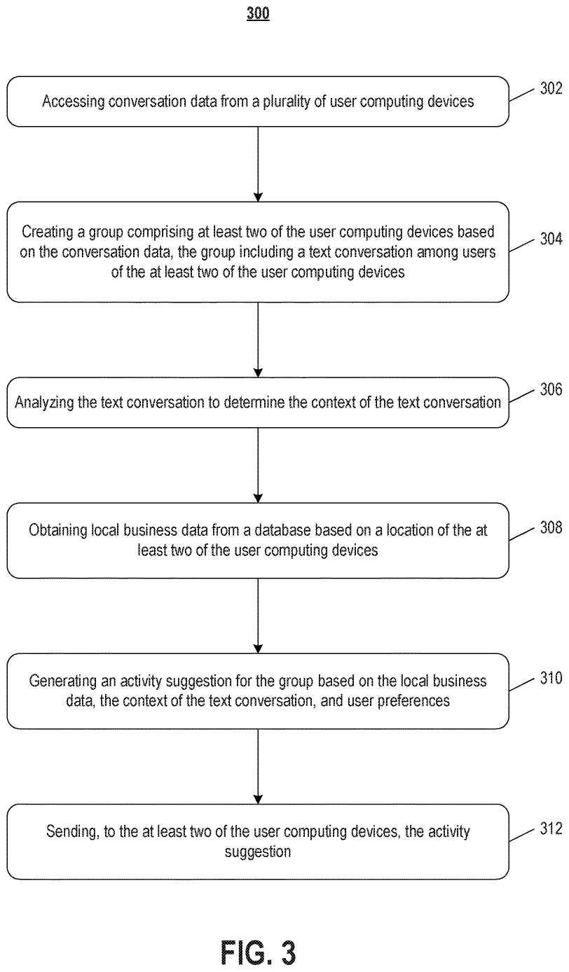

FIG. 3 is a flowchart diagram illustrating an example embodiment of a method 300 of the present disclosure. In certain embodiments, the method 300 for providing a platform for user interactions using artificial intelligence may include the step of providing at least one memory 106. In some embodiments, the at least one memory 106 may include the machine learning model(s) 116. The at least one memory 106 may store non-transitory computer-executable instructions 108 for providing a platform for user interactions using artificial intelligence. When executed by the computing device 102 with the at least one processor 104, the non-transitory computer-executable instructions 108 cause the at least one processor 104 to perform operations 302-312.

In some embodiments, operation 302 may include receiving message data associated with a plurality of user computing devices participating in a group communication session. The message data may include text data, metadata, timestamps, and user identifiers corresponding to individual participants. The received message data may be preprocessed to extract features including linguistic features, temporal features, and user-specific interaction data.

In some embodiments, the message data may include voice-based inputs, including spoken interactions or audio messages. The system may process the voice-based inputs by converting the inputs into structured or textual representations using speech recognition techniques and integrating the converted data into the conversation context.

Operation 304 may include forming or identifying a group communication session comprising at least two of the user computing devices based on the message data, including establishing or maintaining a text-based conversation among the users.

Operation 306 may include generating and processing a conversation context associated with the plurality of user computing devices. The conversation context may include participant-specific interaction data and relational context among the plurality of users. One or more machine learning models may process the conversation context to determine contextual characteristics and group interaction parameters.

In some embodiments, operation 308 may include accessing location-based data associated with one or more external data sources, including local business databases, event listings, or geographic data corresponding to one or more of the user computing devices. The method may further include correlating the conversation context, the contextual characteristics, and the group interaction parameters with the location-based data to identify one or more candidate real-world activities.

In some embodiments, the external data sources may include calendar systems, scheduling platforms, event databases, user preference repositories, and third-party data services that provide contextual or constraint-based information. The computing device may integrate such data sources to determine availability, filter candidate activities, and optimize coordination feasibility.

In some embodiments, correlating the conversation context and the group interaction parameters with the location-based data may include generating a feature vector representing the conversation context and the group interaction parameters and comparing the feature vector to attributes associated with candidate activities. The attributes associated with candidate activities may include activity type, time availability, location proximity, and historical engagement data. The correlation may include calculating similarity scores, applying weighted scoring functions, or using one or more machine learning models trained to map conversation features to activity categories.

Operation 310 may include selecting a candidate real-world activity based on the correlation and generating an activity recommendation comprising at least a proposed location and a proposed time. In some embodiments, selecting the candidate real-world activity may include applying a ranking model that evaluates candidate activities based on weighted combinations of contextual characteristics, group interaction parameters, and external data attributes.

Operation 312 may include transmitting the activity recommendation to at least two of the user computing devices associated with the group communication session. In some embodiments, the activity recommendation may include structured data formatted for integration with a calendar application or user interface.

In some embodiments, the system may handle incomplete, ambiguous, or conflicting message data by applying fallback strategies, including confidence scoring of extracted features, deferring activity recommendation until sufficient data is available, or requesting additional input from one or more users. The system may further detect inconsistencies in user-provided or inferred data and resolve such inconsistencies using priority rules or probabilistic models.

In some embodiments, the method 300 may further include continuously updating the conversation context based on incoming message data to maintain participant-specific context and relational context across the group communication session. The updating may include incrementally modifying stored interaction data and relational context without reprocessing the entire conversation history.

In some embodiments, the method may further include aggregating conversation context across multiple group communication sessions associated with one or more users and generating a cross-session context used to inform participant selection, activity recommendation, and plan generation.

The presently disclosed systems and methods have a wide application anywhere in the social media industry where providing a platform for user interactions using artificial intelligence is needed. One particularly important application for the systems and methods described herein relates to using AI to generate group chats with multiple users based on the users'characteristics and data history and to facilitate the conversations and in-person meet-ups. Additional systems and methods include providing AI-based chat systems for multi-user conversations in applications outside of social media. However, the systems and methods described above could be utilized in other contexts.

As used herein, the term “computing device” may include a processor-controlled device, such as, by way of example, a personal computer, workstation, server, client, mini-computer, mainframe computer, desktop computer, laptop computer, smartphone, tablet, network of one or more individual computers, mobile computer, portable computer, handheld computer, or any combination thereof. The described systems and techniques may be performed by a system that includes a single computing device or more than one computing device.

A computing device may include an integrated circuit (IC) and may include an application-specific integrated circuit (ASIC) or some other type of IC. A computing device may be a uniprocessor or multiprocessor machine. Accordingly, a computing device may include one or more processors and, thus, the system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field-programmable gate arrays (FPGAs), programmable logic devices (PLDs), programmable logic controllers (PLCs), gated logic, and other suitable hardware configured to perform the various functionality described throughout this disclosure. In some embodiments, features of the system can be implemented primarily in hardware using, for example, hardware components such as application-specific integrated circuits (ASICs) or field-programmable gated arrays (FPGAs). Implementation of the hardware circuitry will be apparent to persons skilled in the relevant art(s). In yet another embodiment, features of the system can be implemented using a combination of both general-purpose hardware and software.

The computing device may include at least one memory. Accordingly, the system may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, videotapes, audio tapes, magnetic recording tracks, magnetic tunnel junction (MTJ) memory, optical memory storage, quantum mechanical storage, electronic networks, and/or other devices or technologies used to store electronic content such as programs and data. A basic input/output system (BIOS) can include basic routines that help to transfer information between elements within the system, such as during start-up, can be stored in the one or more memories.

The system can also include one or more storage devices. Examples of a storage device include, but are not limited to, a hard disk drive, a magnetic disk drive, an optical disc drive in combination with an optical medium, a solid-state memory device, or any combination thereof. A storage device can be connected to a bus by an appropriate interface, such as an SCSI, advanced technology attachment (ATA), serial ATA, universal serial bus (USB), IEEE 1394 (FIREWIRE), or any combination thereof. A storage device (or one or more components thereof) can be removably interfaced with the system (e.g., via an external port connector). The storage device and an associated computer-readable medium can provide nonvolatile and/or volatile storage of computer-executable instructions, data structures, program modules, and/or other data for the system.

In particular, the one or more memories may store computer-executable instructions that, when executed by the one or more processors, cause the one or more processors to implement the procedures and techniques described herein. The one or more processors may be operably associated with the one or more memories so that the computer-executable instructions can be provided to the one or more processors for execution. For example, the one or more processors may be operably associated to the one or more memories through one or more buses. Furthermore, the computing device may possess or may be operably associated with input devices (e.g., a keyboard, a keypad, controller, a mouse, a microphone, a touch screen, a sensor) and output devices such as (e.g., a computer screen, printer, or a speaker).

The computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, C++ or the like, and conventional procedural programming languages, such as the C programming language or similar programming languages. The computer readable program instructions may execute on a supercomputer, a compute cluster, or the like. The computer-executable instructions described herein can be downloaded to respective computing/processor devices from a computer-readable storage medium or to an external computer or external storage device via a network, for example, the Internet, a local area network (LAN), a wide area network (WAN) and/or a wireless network. The network may comprise copper transmission cables, optical transmission fibers, wireless transmission, routers, firewalls, switches, gateway computers and/or edge servers. A network adapter card or network interface in each computing/processor device receives computer readable program instructions from the network and forwards the computer readable program instructions for storage in a computer readable storage medium within the respective computing/processor device.

The computing device may execute an appropriate operating system such as LINUX®, UNIX®, MICROSOFT® WINDOWS®, APPLE® MACOS®, IBM® OS/2®, ANDROID, and/or the like. The computing device may advantageously be equipped with a network communication device such as a network interface card, a modem, or other network connection device suitable for connecting to one or more networks.

A computing device may advantageously contain control logic, or program logic, or other substrate configuration representing data and instructions, which cause the computing device to operate in a specific and predefined manner as, described herein. In particular, the computing device programs, when executed, enable a control processor to perform and/or cause the performance of features or operations of the present disclosure. The control logic may advantageously be implemented as one or more modules. The modules may advantageously be configured to reside on the computing device memory and execute on the one or more processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and/or the like. The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells. The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent. In some embodiments, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer readable medium(s) having program code embodied thereon.

It should be understood that manipulations within the computing device are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computing device or computing devices.

It should also be understood that the programs, modules, processes, methods, and the like, described herein are but an exemplary implementation and are not related, or limited, to any particular computing device, apparatus, or computer language. Rather, various types of general-purpose computing machines or devices may be used with programs constructed in accordance with some of the teachings described herein. In some embodiments, very specific computing machines, with specific functionality, may be required. Similarly, it may prove advantageous to construct a specialized apparatus to perform the method steps described herein by way of dedicated systems with hard-wired logic or programs stored in nonvolatile memory, such as, by way of example, read-only memory (ROM).

The system may include one or more machine learning models, such as neural networks. The machine learning models may include supervised or unsupervised learning algorithms. For example, a neural network may include a deep neural network (DNN) (e.g., a deep auto-encoder neural network (deep ANN) or a convolutional neural network (CNN)) with an input layer, a plurality of hidden layers, and an output layer. Each layer may have one or more nodes where each node in a current layer is connected to every other node in a previous layer and a next layer (i.e., a fully-connected neural network), or not every node in each layer may be connected to every node in the previous and next layers. Each node in the input layer can be assigned a value and output that value to every node in the next layer (e.g., hidden layer). The nodes in the input layer can represent features about a particular environment or setting. Each node in the hidden layers can receive an outputted value from nodes in a previous layer (e.g., input layer) and associate each of the nodes in the previous layer with a weight. Each hidden node can then multiply each of the received values from the nodes in the previous layer with the weight associated with the nodes in the previous layer and output the sum of the products to each node in the next layer. Nodes in the output layer can handle input values received from the nodes in the hidden layer in a similar fashion. The output value of each output node can output information in a predefined format, where the information has some relationship to the corresponding information from the previous layer. Example outputs may include, but are not limited to, classifications, relationships, measurements, instructions, and recommendations. The output nodes can also be used to classify any of a wide variety of objects and other features and otherwise output any of a wide variety of desired information in desired formats.

Once a given network has been structured for a task, the neural network can be trained using a training dataset. A training system may use a training dataset to train the machine learning models to perform various functions based on input data to predict output data. Supervised learning uses a training dataset to teach models to yield the desired output. The training dataset can include inputs and desired outputs, which allow the model to learn over time. The network processes the inputs and compares the resulting outputs against a set of expected or desired outputs. Errors are then propagated back through the system. The training can adjust to change the weights that control the untrained neural network. The training process occur can repeatedly as the network weights are adjusted to refine the output generated by the neural network. The training process can continue until the neural network reaches a statistically desired accuracy associated with a trained neural network. The trained neural network can then be deployed to implement any number of machine learning operations to output a result. Unsupervised learning is a learning method in which the network uses algorithms to analyze and cluster unlabeled data to discover hidden patterns or data groupings. The training dataset includes input data without any associated output data. The untrained neural network can learn groupings within the unlabeled input and determine how individual inputs relate to the overall dataset. Unsupervised training can be used to for three main tasks—clustering, association, and dimensionality. Clustering is a data mining technique that groups unlabeled data based on similarities and differences, association is a rule-based method for finding relationships between variables in a given dataset, and dimensionality reduction is used when a given dataset's number of features (dimensions) is too high. Variations of supervised and unsupervised training may also be employed. Semi-supervised learning is a technique in which the training dataset includes a mix of labeled and unlabeled data of the same distribution. Incremental learning is a variant of supervised learning in which input data is continuously used to train the model further. Incremental learning enables the trained neural network to adapt to the new data without forgetting the knowledge instilled within the network during initial training.

In some embodiments, the training dataset used to train the one or more machine learning models may include historical multi-user conversation data, user interaction logs, activity participation records, and feedback data associated with prior recommendations. The training process may optimize the mapping between conversation features and successful real-world activity outcomes.

A convolutional neural network (CNN) is a type of DNN having three additional features: local receptive fields, shared weights, and pooling. The input layer and output layer of a CNN function similar to the input and output layers of a DNN. The CNN is distinguished from a DNN in that the hidden layers of the DNN are replaced with one or more convolutional layers, pooling layers, and fully connected layers. The use of localized receptive fields involves having nodes in the convolutional layers to receive inputs from localized regions in the previous layer. The use of shared weights involves having each node in a convolutional layer assigning the same set of weights to the relative positions of a localized region. The input layer of the CNN can include data representing an image. The image can be passed through a convolutional hidden layer, an optional non-linear activation layer, a pooling hidden layer, and/or a fully connected hidden layers to get an output at the output layer. The convolutional hidden layer analyzes the image data of the input layer. Each node of the convolutional hidden layer is connected to a region of nodes (pixels) of the input image called a receptive field. The convolutional hidden layer can be considered as one or more filters (each filter corresponding to a different activation or feature map), with each convolutional iteration of a filter being a node or neuron of the convolutional hidden layer. The mapping from the input layer to the convolutional hidden layer is referred to as an activation map or feature map. The activation map includes a value for each node representing the filter results at each location of the input volume. The activation map can include an array containing the various total sum values resulting from each iteration of the filter on the input volume. The convolutional hidden layer can include several activation maps to identify multiple features in an image. A pooling hidden layer can be applied after the convolutional hidden layer and is used to simplify the information in the output from the convolutional hidden layer. The pooling hidden layer can take each activation map output from the convolutional hidden layer and generate a condensed activation map using a pooling function. The pooling function can be applied to each activation map in the convolutional hidden layer. The final layer of connections in the network is a fully connected layer that connects every node from the pooling hidden layer to every one of the output nodes in the output layer. The fully connected layer can obtain the output of the previous pooling layer, which should represent the activation maps of high-level features, and determine the features that most correlate to a particular class. For example, the fully connected layer can determine the high-level features that most strongly correlate to a particular class and can include weights (nodes) for the high-level features. A product can be computed between the weights of the fully connected layer and the pooling hidden layer to obtain probabilities for the different classes. For example, if the CNN is being used to predict that an object is a person, high values will be present in the activation maps that represent high-level features of people (e.g., two legs are present, a face is present at the top of the object, two eyes are present at the top left and top right of the face, a nose is present in the middle of the face, etc.).

Aspects of the present disclosure are described herein with reference to flowchart illustrations or block diagrams of methods, apparatuses, systems, or computer program products according to embodiments of the disclosure. It will be understood that each block of the flowchart illustrations and/or block diagrams, and combinations of blocks in the flowchart illustrations and/or block diagrams, can be implemented by computer-executable instructions. These computer-executable instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-executable instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The schematic flow chart diagrams included herein are generally set forth as logical flow chart diagrams. As such, the depicted order and labeled steps are indicative of one embodiment of the presented method. Other steps and methods may be conceived that may be equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown. The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions of the program code for implementing the specified logical function(s).

Those skilled in the art will recognize improvements and modifications to the preferred embodiments of the present disclosure. All such improvements and modifications are considered within the scope of the concepts disclosed herein and the claims that follow.

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those skilled in the art will recognize, or be able to ascertain, using no more than routine experimentation, numerous equivalents to the specific substances and procedures described herein. Such equivalents are considered to be within the scope of this disclosure and are covered by the following exemplary claims.

Furthermore, the described features, structures, or characteristics of the disclosure may be combined in any suitable manner in one or more embodiments. In the description contained herein, numerous specific details are provided to provide understanding of embodiments of the disclosure. One skilled in the relevant art will recognize, however, that the disclosure may be practiced without one or more of the specific details, or with other methods, components, materials, apparatuses, devices, systems, and so forth. In other instances, well-known structures, materials, or operations may not be shown or described in detail to avoid obscuring aspects of the disclosure.

What is claimed is:

1. A computer-implemented method for managing multi-user interactions, comprising:
receiving, by a computing system comprising one or more processors and one or more machine learning models, message data associated with a plurality of user computing devices participating in one or more group communication sessions;
generating, by the computing system, conversation context associated with the plurality of user computing devices based on the message data, including interaction data associated with individual users and relational context among the plurality of users;
aggregating, by the computing system, the conversation context across the one or more group communication sessions to generate a cross-session context associated with at least one user;
processing, by the one or more machine learning models, the cross-session context to:
determine one or more contextual characteristics associated with a group communication session; and
identify one or more group interaction parameters including at least one of participation distribution, response timing, or sentiment variation;
generating, by the computing system, a structured plan including at least a set of participants, a proposed time, and a proposed location;
selecting, by the computing system, a candidate real-world activity by:
accessing location-based data associated with one or more external data sources; and
correlating the conversation context and the group interaction parameters with the location-based data;
generating, by the computing system, a coordination output including at least an activity recommendation including at least a location and a proposed time; and
transmitting, to at least two of the user computing devices, the activity recommendation,
wherein the conversation context is updated based on incoming message data to maintain context associated with individual users across the one or more group communication sessions.

2. The method of claim 1, further comprising:
analyzing the conversation context to determine at least one of silence duration, participation imbalance, or conversational cohesion;
determining a timing condition for automated system intervention based on the conversation context; and
generating and inserting an AI-generated message into the group communication session in response to the timing condition,
wherein the AI-generated message is generated without receiving an explicit user request.

3. The method of claim 2, wherein processing the conversation context further comprises:
detecting tonal divergence within the group communication session; and
selecting a response strategy based on the tonal divergence,
wherein the AI-generated message comprises a mediating message configured to reduce the tonal divergence.

4. The method of claim 1, wherein identifying the one or more group interaction parameters comprises:
determining participation distribution based on message frequency per participant;
determining response timing based on time intervals between messages; and
determining sentiment variation based on changes in detected sentiment across the group communication session.

5. The method of claim 1, wherein selecting the candidate real-world activity further comprises:
identifying a plurality of candidate activities based on the location-based data;
determining availability and scheduling constraints associated with the plurality of user computing devices; and
selecting the candidate real-world activity based on the conversation context and the availability and scheduling constraints including calendar-based availability data.

6. The method of claim 1, wherein generating the activity recommendation further comprises:
generating a calendar appointment including at least the location and the proposed time; and
transmitting the calendar appointment to the at least two of the user computing devices.

7. The method of claim 1, further comprising:
determining that an additional user computing device is compatible based on the cross-session context; and
adding the additional user computing device to the group communication session.

8. The method of claim 1, further comprising:
aggregating conversation context across the group communication session and a second group communication session to generate the cross-session context.

9. The method of claim 1, wherein the one or more machine learning models comprise one or more large language models configured to process natural language message data.

10. The method of claim 1, wherein generating the conversation context further comprises:
generating interaction histories associated with each user computing device; and
maintaining the interaction histories across multiple messages and across multiple group communication sessions.

11. The method of claim 1, wherein selecting the candidate real-world activity further comprises:
weighting the location-based data based on proximity to the plurality of user computing devices.

12. The method of claim 1, wherein receiving the message data comprises receiving communication data including at least one of text-based data or voice-based data exchanged between at least two user computing devices.

13. The method of claim 1, further comprising determining geolocation data associated with the plurality of user computing devices.

14. The method of claim 1, wherein selecting the candidate real-world activity further comprises:
correlating the conversation context with user preference data associated with the plurality of users and behavioral data derived from prior interactions.

15. The method of claim 1, wherein transmitting the activity recommendation further comprises:
transmitting the activity recommendation to a user interface associated with each of the at least two user computing devices.

16. The method of claim 1, further comprising:
determining a relationship stage of the group communication session based on the cross-session context; and
generating a user interface element based on the relationship stage.

17. The method of claim 1, further comprising:
selecting a machine learning model from among a plurality of machine learning models based on at least one of conversation complexity, context depth, or responsiveness requirements.

18. The method of claim 1, wherein processing the conversation context comprises maintaining conversational context across multiple participants by identifying and tracking individual users across the one or more group communication sessions.

19. A system for managing multi-user interactions, comprising:
at least one processor;
at least one memory storing non-transitory computer-executable instructions; and
one or more machine learning models;
wherein execution of the instructions causes the system to:
receive message data associated with a plurality of user computing devices participating in a group communication session;
generate conversation context including interaction data associated with individual users and relational context among the plurality of users;
aggregate the conversation context across multiple group communication sessions to generate a cross-session context;
process the conversation context to determine one or more contextual characteristics associated with the group communication session and one or more group interaction parameters;
select a candidate real-world activity based on the conversation context, the group interaction parameters, and location-based data obtained from one or more external data sources;
generate a structured plan and initiate coordination actions associated with the structured plan; and
transmit an activity recommendation to at least two of the user computing devices.

20. A system for managing multi-user interactions, comprising:
a computing device including at least one processor, at least one memory, and one or more machine learning models; and
a plurality of user computing devices, each associated with a user;
wherein the computing device is configured to:
receive message data from the plurality of user computing devices;
generate conversation context associated with a group communication session;
aggregate the conversation context across the one or more group communication sessions to generate a cross-session context;
determine a relationship stage based on the cross-session context;
generate a structured plan including at least participants, a proposed time, and a proposed location based on the cross-session context;
generate a coordination output including at least an activity recommendation based on the cross-session context and location-based data;
generate a user interface element based on the relationship stage; and
transmit the activity recommendation and the user interface element to at least two of the user computing devices.
